(19) United States
(12) Patent Application Publication
(10) Pub. No.: US 2023/0318153 A1
(43) Pub. Date: Oct. 5, 2023

(54) SOLID-STATE BATTERY

(71) Applicant: HONDA MOTOR CO., LTD., Minato-ku, Tokyo (JP)

(72) Inventors: Shigemitsu Akutsu, Wako-shi (JP); Shigeru Koyama, Wako-shi (JP)

(21) Appl. No.: 18/125,851

(22) Filed: Mar. 24, 2023

(30) Foreign Application Priority Data
Mar. 31, 2022 (JP) 2022-058294

(51) Int. Cl. H01M 50/54; H01M 50/129; H01M 50/172

(52) U.S. Cl. CPC H01M 50/54; H01M 50/129; H01M 50/172

(57) ABSTRACT

A solid-state battery includes stacked electrode body, and exterior film that accommodates stacked electrode body, stacked electrode body has first stacked electrode body stacked such that both stacked end outermost surfaces become negative electrode current collector layer, and second stacked electrode body stacked such that both stacked end outermost surfaces become positive electrode current collector layer, first negative electrode bundled body of negative electrode current collector layer and first positive electrode bundled body of positive electrode current collector layer are connected in series, exterior film has inner resin layer, metal layer, and outer resin layer, and first internal connecting portion that electrically connects first negative electrode bundled body and first positive electrode bundled body to metal layer is provided at one end portion of stacked electrode body in width direction to which first negative electrode bundled body and first positive electrode bundled body are connected in series.

### CROSS-REFERENCE TO RELATED APPLICATION

Priority is claimed on Japanese Patent Application No. 2022-058294, filed Mar. 31, 2022, the content of which is incorporated herein by reference.

### BACKGROUND OF THE INVENTION

### Field of the Invention

The present invention relates to a solid-state battery.

### Description of Related Art

In recent years, in order to ensure access to affordable, reliable, sustainable and advanced energy for more people, research and development have been carried out on solid-state batteries that contribute to energy efficiency.

Large-capacity laminated pouch cells for electric automobiles generally have electrode tabs on both ends in a longitudinal direction. For this reason, when stacking and connecting them in series or in parallel, it is necessary to provide a space for a bus bar to connect terminals of battery cells on both ends of the battery cell in the longitudinal direction. The space cannot extend in the longitudinal direction of the electrodes in the battery cell.

In order to monitor voltages of all battery cells, it is necessary to extract wiring for a computer-controlled vehicle system (CVS) from positive electrode ends and negative electrode terminals of all cells. For this reason, a part of the wiring for a CVS must cross a module, and the space needs to be secured. For this reason, the volume that can be occupied by stacked cells is reduced. That is, a battery capacity is reduced.

As a technology of increasing a volume that can be occupied by stacked cells, for example, it is known that a protrusion length of a tab lead can be shortened by hollowing out an inner resin layer that constitutes a laminated film and connecting it to a power generating element (for example, see Japanese Unexamined Patent Application, First Publication No. 2012-28023).

### SUMMARY OF THE INVENTION

Incidentally, in technologies related to a solid-state battery, the electrode area cannot be widened inside the laminated pouch cell. In addition, at inside of the laminated pouch cell, there is a problem in which a space factor of the electrode cannot be increased.

The present application is directed to accomplishing enlargement of an electrode area and an increase in space factor of the electrode in a laminated pouch cell. Further, the present application contributes to energy efficiency.

An aspect of the present invention provides the following configurations.

A solid-state battery includes: a stacked electrode body, and an exterior film configured to accommodate the stacked electrode body,
wherein the stacked electrode body at least has a first stacked electrode body stacked such that both stacked end outermost surfaces become a negative electrode current collector layer, and a second stacked electrode body stacked such that both stacked end outermost surfaces become a positive electrode current collector layer,
a negative electrode bundled body of a negative electrode current collector layer of the first stacked electrode body and a positive electrode bundled body of a positive electrode current collector layer of the second stacked electrode body are connected in series,
the exterior film has an inner resin layer, a metal layer, and an outer resin layer, and
an internal connecting portion configured to electrically connect the negative electrode bundled body and the positive electrode bundled body to the metal layer is provided at one end portion of the stacked electrode body in the width direction to which the negative electrode bundled body and the positive electrode bundled body are connected in series.

An electrode area of the stacked electrode body can be enlarged and a space factor of the electrode of the stacked electrode body can be increased in the exterior film by (i) connecting the negative electrode bundled body of the negative electrode current collector layer of the first stacked electrode body and the positive electrode bundled body of the positive electrode current collector layer of the second stacked electrode body in series and (ii) providing the internal connecting portion configured to electrically connect the negative electrode bundled body and the positive electrode bundled body to the metal layer of the exterior film at one end portion of the stacked electrode body in the width direction at which the negative electrode bundled body and the positive electrode bundled body are connected in series.

The solid-state battery according to the above-mentioned [1], wherein the positive electrode bundled body of the positive electrode current collector layer of the first stacked electrode body and the negative electrode bundled body of the negative electrode current collector layer of the second stacked electrode body are each bonded to tab leads at other end portion of the stacked electrode body in the width direction,

the exterior film has an exposed portion from which the metal layer is exposed and which is electrically connected to electrical equipment outside the solid-state battery in the other end portion of the stacked electrode body in the width direction.

Since the positive electrode bundled body of the positive electrode current collector layer of the first stacked electrode body and the negative electrode bundled body of the negative electrode current collector layer of the second stacked electrode body are each bonded to the tab leads in the other end portion of the stacked electrode body in the width direction, and the exterior film has the exposed portion where the metal layer is exposed electrically connected to the electrical equipment outside the solid-state battery in the other end portion of the stacked electrode body in the width direction, the potential in the solid-state battery can be extracted.

According to the aspect of the present invention, at inside of the laminated pouch cell, the electrode area in the stacked electrode body can be enlarged, and the space factor of the electrode in the stacked electrode body can be increased.

### BRIEF DESCRIPTION OF THE DRAWINGS

FIG. 1 is a cross-sectional view showing an example of a solid-state battery according to an embodiment of the present invention.

FIG. 2 is a plan view showing an example of a structure of a first stacked electrode body that constitutes the solid-state battery according to the embodiment of the present invention.

FIG. 3 is a plan view showing an example of a structure of a second stacked electrode body that constitutes the solid-state battery according to the embodiment of the present invention.

FIG. 4 is a plan view showing an example of a structure of a stacked electrode body that constitutes the solid-state battery according to the embodiment of the present invention.

FIG. 5 is a schematic diagram for describing that a potential of a connecting center between a first stacked electrode body and a second stacked electrode body is equal to a potential between both stacked ends of the first stacked electrode body and the second stacked electrode body.

FIG. 6 is a schematic diagram for describing that a potential of the connecting center between the first stacked electrode body and the second stacked electrode body is equal to a potential between both stacked ends of the first stacked electrode body and the second stacked electrode body.

### DETAILED DESCRIPTION OF THE INVENTION

Hereinafter, an embodiment of the present invention will be described in detail with reference to the accompanying drawings.

### Configuration of Solid-state Battery

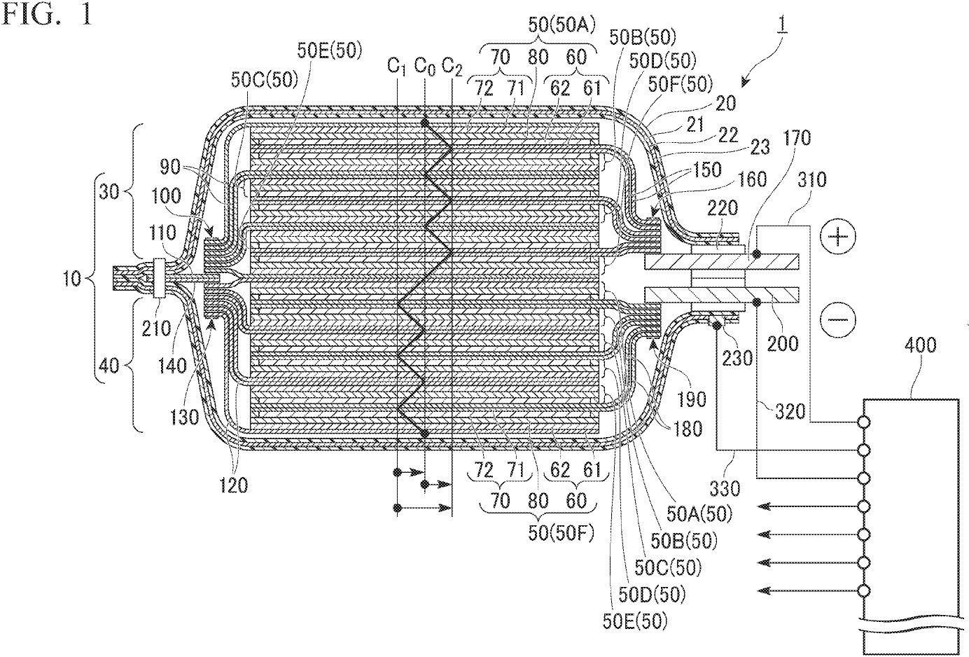

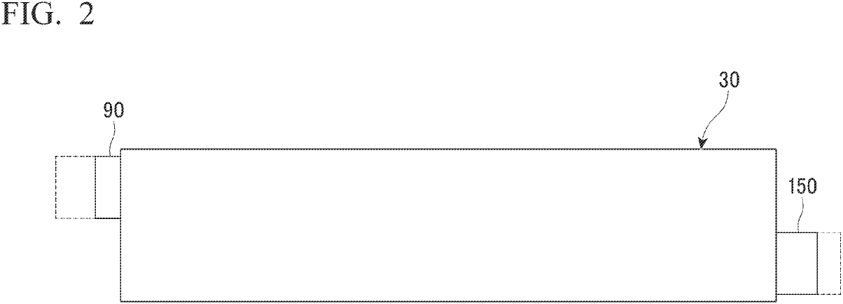

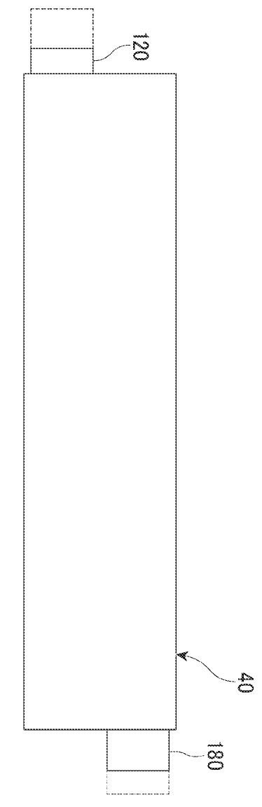

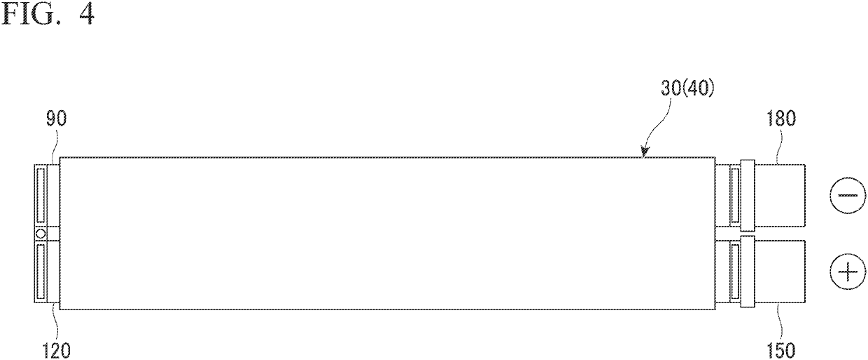

FIG. 1 is a cross-sectional view showing an example of a solid-state battery according to an embodiment of the present invention. FIG. 2 is a plan view showing an example of a structure of a first stacked electrode body that constitutes the solid-state battery according to the embodiment of the present invention. FIG. 3 is a plan view showing an example of a structure of a second stacked electrode body that constitutes the solid-state battery according to the embodiment of the present invention. FIG. 4 is a plan view showing an example of a structure of a stacked electrode body that constitutes the solid-state battery according to the embodiment of the present invention. Further, in the drawings used in the following description, in order to make features easier to understand, characteristic parts may be enlarged for convenience, and a dimensional ratio or the like of each component is not limited to that shown in the drawings.

A solid-state battery 1 includes a stacked electrode body 10, and an exterior film 20 configured to accommodate the stacked electrode body 10. The stacked electrode body 10 has a first stacked electrode body 30, and a second stacked electrode body 40.

The first stacked electrode body 30 and the second stacked electrode body 40 have a plurality of single layer sheet electrodes 50. In FIG. 1, the first stacked electrode body 30 and the second stacked electrode body 40 have six single layer sheet electrodes 50 (a first single layer sheet electrode 50A, a second single layer sheet electrode 50B, a third single layer sheet electrode 50C, a fourth single layer sheet electrode 50D, a fifth single layer sheet electrode 50E and a sixth single layer sheet electrode 50F).

The single layer sheet electrode 50 has a positive electrode 60, a negative electrode 70, and a solid electrolyte layer 80 disposed between the positive electrode 60 and the negative electrode 70 and including a solid electrolyte.

The positive electrode 60 is obtained by stacking a positive electrode current collector layer 61, and a positive electrode active material layer 62 including at least a solid electrolyte.

The negative electrode 70 is obtained by stacking a negative electrode current collector layer 71, and a negative electrode active material layer 72 including at least a solid electrolyte.

The first stacked electrode body 30 has the plurality of single layer sheet electrodes 50 stacked such that both stacked end outermost surfaces become the negative electrode current collector layer 71. Specifically, in the first stacked electrode body 30, the negative electrode current collector layer 71 of the first single layer sheet electrode 50A forms one outermost surface (in FIG. 1, an upper surface side of the first stacked electrode body) in the stacking direction. Further, the negative electrode current collector layer 71 of the sixth single layer sheet electrode 50F forms the other outermost surface (in FIG. 1, a lower surface side of the first stacked electrode body) in the stacking direction.

The second stacked electrode body 40 has the plurality of single layer sheet electrodes 50 stacked such that both stacked end outermost surfaces become the positive electrode current collector layer 61. Specifically, in the second stacked electrode body 40, the positive electrode current collector layer 61 of the first single layer sheet electrode 50A forms one outermost surface (in FIG. 1, an upper surface side of the second stacked electrode body) in the stacking direction. Further, the positive electrode current collector layer 61 of the sixth single layer sheet electrode 50F forms the other outermost surface (in FIG. 1, a lower surface side of the second stacked electrode body) in the stacking direction.

In one end portion of the stacked electrode body 10 in the width direction, a first tab lead 90 is bonded to the negative electrode current collector layer 71 of the first stacked electrode body 30. The first tab lead 90 is bundled to form a first negative electrode bundled body 100. A first clad material 110 is bonded to the first negative electrode bundled body 100.

In one end portion of the stacked electrode body 10 in the width direction, a second tab lead 120 is bonded to the positive electrode current collector layer 61 of the second stacked electrode body 40. The second tab lead 120 is bundled to form a first positive electrode bundled body 130. A second clad material 140 is bonded to the first positive electrode bundled body 130.

When the first clad material 110 and the second clad material 140 are bonded, the first negative electrode bundled body 100 and the first positive electrode bundled body 130 are connected in series.

In the other end portion of the stacked electrode body 10 in the width direction, a third tab lead 150 is bonded to the positive electrode current collector layer 61 of the first stacked electrode body 30. The third tab lead 150 is bundled to form a second positive electrode bundled body 160. A fourth tab lead 170 is bonded to the second positive electrode bundled body 160.

In the other end portion of the stacked electrode body 10 in the width direction, a fifth tab lead 180 is bonded to the negative electrode current collector layer 71 of the second stacked electrode body 40. The fifth tab lead 180 is bundled to form a second negative electrode bundled body 190. A sixth tab lead 200 is bonded to the second negative electrode bundled body 190.

The fourth tab lead 170 is a positive electrode terminal to which the first stacked electrode body 30 and the second stacked electrode body 40 are connected in series, and the sixth tab lead 200 is a negative electrode terminal to which the first stacked electrode body 30 and the second stacked electrode body 40 are connected in series.

The exterior film 20 has an inner resin layer 21, a metal layer 22, and an outer resin layer 23.

In one end portion of the first stacked electrode body 30 and the second stacked electrode body 40 in the width direction to which the first negative electrode bundled body 100 and the first positive electrode bundled body 130 are connected in series, a first internal connecting portion 210 configured to electrically connect the first negative electrode bundled body 100 and the first positive electrode bundled body 130 to the metal layer 22 of the exterior film 20 is provided.

In the other end portion of the first stacked electrode body 30 and the second stacked electrode body 40 in the width direction to which the first negative electrode bundled body 100 and the first positive electrode bundled body 130 are connected in series, a terminal portion 230 for CVS wiring connected to the metal layer 22 of the exterior film 20 is provided.

The fourth tab lead 170 is connected to a CVS 400 via a wiring 310. The sixth tab lead 200 is connected to the CVS 400 via a wiring 320. The terminal portion 230 for CVS wiring is connected to the CVS 400 via a wiring 330. At the other end portion of the stacked electrode body 10 in the width direction, the exterior film 20 has an exposed portion from which the metal layer 22 is exposed and which is electrically connected to electrical equipment (the CVS 400 or the like) outside the solid-state battery 1. At the exposed portion, the metal layer 22 of the exterior film 20 is connected to the terminal portion 230 for CVS wiring.

### Positive Electrode

The positive electrode 60 is obtained by stacking the positive electrode current collector layer 61, and the positive electrode active material layer 62 including at least a solid electrolyte. In the embodiment, the positive electrode 60 has the positive electrode current collector layer 61, and the positive electrode active material layer 62 formed on one main surface of the positive electrode current collector layer 61 and including a positive electrode active material and a solid electrolyte.

The positive electrode current collector layer 61 is preferably composed of at least one material having a high conductance.

As the high conductive material, for example, a metal or alloy including at least any one metal element of silver (Ag), palladium (Pd), gold (Au), platinum (Pt), aluminum (Al), copper (Cu), chrome (Cr), and nickel (Ni), or a non-metal such as carbon (C) is exemplified. In consideration of manufacturing costs in addition to a level of conductivity, aluminum, nickel or stainless steel is preferable. Further, aluminum is difficult to react with a positive electrode active material, a negative electrode active material and a solid electrolyte. For this reason, when aluminum is used in the positive electrode current collector layer 61, an internal resistance of the solid-state battery can be reduced.

As a shape of the positive electrode current collector layer 61, for example, a foil shape, a plate shape, a mesh shape, a non-woven fabric shape, a foaming shape, or the like, may be exemplified. In addition, in order to increase adhesion to the positive electrode active material layer 62, carbon or the like may be disposed on the surface of the positive electrode current collector layer 61, or the surface may be roughened.

The positive electrode active material layer 62 includes a positive electrode active material that receives lithium ions and electrons. The positive electrode active material is not particularly limited as long as it is a material that can reversibly discharge and absorb lithium ions and through which electron transport is performed, and a known positive electrode active material applicable to the positive electrode of the all-solid type lithium ion battery can be used. For example, complex oxide such as lithium cobalt oxide (LiCoO₂), lithium nickel oxide (LiNiO₂), lithium manganese oxide (LiMn₂O₄), solid solution oxide (Li₂MnO₃-LiMO₂ (M = Co, Ni or the like)), lithium-manganese-nickel-cobalt oxide (LiNiₓMn_{y}Co_{z}O₂, x+y+z = 1), olivine type lithium phosphorus oxide (LiFePO₄), or the like; conductive polymer such as polyaniline, polypyrrole, or the like; sulfide such as Li₂S, CuS, Li—Cu—S compound, TiS₂, FeS, MoS₂, Li—Mo—S compound, or the like; a mixture of sulfur and carbon, or the like, is exemplified. The positive electrode active material may be composed of one of the above-mentioned materials or may be formed to two or more materials.

The positive electrode active material layer 62 includes a solid electrolyte that receives a positive electrode active material and lithium ions. The solid electrolyte is not particularly limited as long as it has lithium ion conductivity, and a material used in the all-solid type lithium ion battery can be generally used. For example, an inorganic solid electrolyte such as a sulfide solid electrolyte material, an oxide solid electrolyte material, a halide solid electrolyte, a lithium-containing salt, or the like, a polymer-based solid electrolyte such as polyethylene oxide or the like, a lithium-containing salt, a gel-based solid electrolyte including ionic liquid with lithium ion conductivity, or the like, may be exemplified. Among these, a sulfide solid electrolyte material is preferable from the viewpoint of high conduction characteristics of lithium ions and structure formability by a press or good interface boding characteristics.

The solid electrolyte may be composed of only one of the above mentioned materials or may be formed two or more of the above mentioned materials. The solid electrolyte contained in the positive electrode active material layer 62 may be the same material as the solid electrolyte contained in the negative electrode active material layer 72 or the solid electrolyte layer 80 or may be different materials.

The positive electrode active material layer 62 may include a conductive assistant from the viewpoint of improving conductivity of the positive electrode 60. As the conductive assistant, a conductive assistant usable in the all-solid type lithium ion battery can be generally used. For example, a carbon black such as acetylene black, kechen black, or the like; a carbon fiber; a vapor grown carbon fiber; graphite powder; carbon material such as carbon nanotube, or the like, may be exemplified. The conductive assistant may be composed of only one of above mentioned the materials, or may be formed to two or more of the above mentioned materials.

In addition, the positive electrode active material layer 62 may include a binder having a role of attaching the positive electrode active materials each other and attaching the positive electrode active material and the positive electrode current collector layer 61.

In the embodiment, while the positive electrode active material layer 62 is formed on one main surface of the positive electrode current collector layer 61, it is not limited thereto and the positive electrode active material layer 62 may be formed on both the main surfaces of the positive electrode current collector layer 61. In addition, when the positive electrode active material layer 62 has a 3-dimensional porous structure such as a mesh shape, a non-woven fabric shape, a foaming shape, or the like, the positive electrode active material layer 62 may be provided integrally with the positive electrode current collector layer 61.

In the first stacked electrode body 30, the positive electrode current collector layers 61 are assembled at one end portion of the solid-state battery 1 in the width direction. In the second stacked electrode body 40, the positive electrode current collector layers 61 are assembled at the other end portion of the solid-state battery 1 in the width direction.

### Negative Electrode

The negative electrode 70 is obtained by stacking the negative electrode current collector layer 71, and the negative electrode active material layer 72 including at least a solid electrolyte. In the embodiment, the negative electrode 70 has the negative electrode current collector layer 71, and the negative electrode active material layer 72 formed on one main surface of the negative electrode current collector layer 71 and having a negative electrode active material and a solid electrolyte.

The negative electrode current collector layer 71 is preferably composed of at least one material with high conductance, like the positive electrode current collector layer 61. As the material with high conductivity, for example, a metal or alloy including at least any one metal element of silver (Ag), palladium (Pd), gold (Au), platinum (Pt), aluminum (Al), copper (Cu), chrome (Cr) and nickel (Ni), or a non-metal such as carbon (C) is exemplified. In consideration of manufacturing costs in addition to a level of conductivity, copper, nickel or stainless steel is preferable. Further, the stainless steel is difficult to react with a positive electrode active material, a negative electrode active material and a solid electrolyte. For this reason, when the stainless steel is used in the negative electrode current collector layer 71, the internal resistance of the solid-state battery can be reduced.

As a shape of the negative electrode current collector layer 71, for example, a foil shape, a plate shape, a mesh shape, a non-woven fabric shape, a foaming shape, or the like, may be exemplified. In addition, in order to increase adhesion to the negative electrode active material layer 72, carbon or the like may be disposed on the surface of the negative electrode current collector layer 71, or the surface may be roughened.

The negative electrode active material layer 72 includes a negative electrode active material that receives lithium ions and electrons. The negative electrode active material is not particularly limited as long as it is a material that can reversibly discharge and absorb lithium ions and through which electron transport is performed, and a known negative electrode active material applicable to the negative electrode of the all-solid type lithium ion battery can be used. For example, a carbonaceous material such as natural graphite, artificial graphite, resinous coal, carbon fiber, activated charcoal, hard carbon, soft carbon, or the like; an alloy-based material composed of tin, tin alloy, silicon, silicon alloy, gallium, gallium alloy, indium, indium alloy, aluminum, aluminum alloy, or the like, as a main element; a conductive polymer such as polyacene, polyacetylene, polypyrrole, or the like; metal lithium; lithium titanium complex oxide (for example, Li₄Ti₅Oₗ₂), or the like, is exemplified. The negative electrode active material thereof may be composed of only one of the above mentioned materials, or may be two or more of the above mentioned materials.

The negative electrode active material layer 72 includes a solid electrolyte that receives a negative electrode active material and lithium ions. The solid electrolyte is not particularly limited as long as it has lithium ion conductivity, and a material used in the all-solid type lithium ion battery can be generally used. For example, an inorganic solid electrolyte such as a sulfide solid electrolyte material, an oxide solid electrolyte material, a halide solid electrolyte, a lithium-containing salt, or the like, a polymer-based solid electrolyte such as polyethylene oxide or the like, a gel-based solid electrolyte including a lithium-containing salt or ionic liquid with lithium ion conductivity, or the like, may be exemplified. The solid electrolyte may be composed of only one of the above mentioned materials or may be composed of two or more of the above mentioned materials.

The solid electrolyte contained in the negative electrode active material layer 72 may be the same as the solid electrolyte contained in the positive electrode active material layer 62 or the solid electrolyte layer 80 or may be different therefrom.

The negative electrode active material layer 72 may include a conductive assistant, a binder, and the like. While these materials are not particularly limited, for example, the same material as used in the positive electrode active material layer 62 can be used.

In the embodiment, while the negative electrode active material layer 72 is formed on one main surface of the negative electrode current collector layer 71, it is not limited thereto and the negative electrode active material layer 72 may be formed on both the main surfaces of the negative electrode current collector layer 71. In addition, when the negative electrode active material layer 72 has a 3-dimensional porous structure such as a mesh shape, a non-woven fabric shape, a foaming shape, or the like, the negative electrode active material layer 72 may be provided integrally with the negative electrode current collector layer 71.

In the first stacked electrode body 30, the negative electrode current collector layers 71 are assembled at the other end portion of the solid-state battery 1 in the width direction. In the second stacked electrode body 40, the negative electrode current collector layers 71 are assembled at one end portion in the solid-state battery 1 in the width direction.

### Solid Electrolyte Layer

The solid electrolyte layer 80 is disposed between the positive electrode active material layer 62 and the negative electrode active material layer 72.

The solid electrolyte is not particularly limited as long as it has lithium ion conductivity and insulation, and the material used in the all-solid type lithium ion battery can be generally used. For example, an inorganic solid electrolyte such as a sulfide solid electrolyte material, an oxide solid electrolyte material, a halide solid electrolyte, a lithium-containing salt, or the like, a polymer-based solid electrolyte such as polyethylene oxide or the like, a gel-based solid electrolyte including a lithium-containing salt or ionic liquid with lithium ion conductivity, or the like, may be exemplified. Among these, a sulfide solid electrolyte material is preferable from the viewpoint of high conduction characteristics of lithium ions, structure formability by the press, or good interface boding characteristics.

While the shape of the solid electrolyte material is not particularly limited, for example, a particle shape may be exemplified.

The solid electrolyte layer 80 may include an adhesive agent that applies mechanical strength or flexibility.

The solid electrolyte layer 80 may be a sheet-shaped layer having a porous substrate, and a solid electrolyte held on the porous substrate. While the shape of the porous substrate is not particularly limited, for example, a woven fabric, a non-woven fabric, a mesh cloth, a porous membrane, an expanded sheet, a punching sheet, or the like, is exemplified. Among these, the non-woven fabric is preferable from the viewpoint of operability where a filler content of the solid electrolyte is further increased.

The porous substrate is preferably composed of an insulation material. Accordingly, insulation of the solid electrolyte layer 80 can be improved. As the insulation material, for example, resin material such as nylon, polyester, polyethylene, polypropylene, polytetrafluoroethylene, ethylene tetrafluoro ethylene copolymer, polyvinylidene fluoride, polyvinylidene chloride, polyvinyl chloride, polyurethane, vinylon, polybenzimidazole, polyimide, polyphenylene sulfite, polyetheretherketone, cellulose, acrylic resin or the like, natural fiber such as hemp, wood pulp, cotton linter or the like, glass, or the like, is exemplified.

### Exterior Film

The exterior film 20 is a laminated film having the inner resin layer 21, the metal layer 22, and the outer resin layer 23. As the resin that composes the inner resin layer 21 and the outer resin layer 23, for example, a polyester resin such as polyethylene terephthalate (PET) or the like is exemplified. The metal layer 22 is composed of, for example, aluminum foil or the like.

As described above, according to the embodiment, an internal space of the exterior film 20 can be expanded by (i) connecting the first negative electrode bundled body 100 of the negative electrode current collector layer 71 of the first stacked electrode body 30 and the first positive electrode bundled body 130 of the positive electrode current collector layer 61 of the second stacked electrode body 40 in series and (ii) providing the first internal connecting portion 210 configured to electrically connect the first negative electrode bundled body 100 and the first positive electrode bundled body 130 to the metal layer 22 of the exterior film 20 at one end portion of the stacked electrode body 10 in the width direction in which the first negative electrode bundled body 100 and the first positive electrode bundled body 130 are connected in series. For example, in the exterior film 20, an electrode area of the stacked electrode body 10 can be enlarged, and a space factor of the electrode of the stacked electrode body 10 can be increased. Accordingly, an energy density of the solid-state battery 1 can be increased, and installed electric power can be increased.

In addition, according to the embodiment, at the other end portion of the stacked electrode body 10 in the width direction, the second positive electrode bundled body 160 of the positive electrode current collector layer 61 of the first stacked electrode body 30 is bonded to the fourth tab lead 170 and the sixth tab lead 200 is bonded to the second negative electrode bundled body 190 of the negative electrode current collector layer 71 of the second stacked electrode body 40, and at the other end portion of the stacked electrode body 10 in the width direction, the exterior film 20 has an exposed portion from which the metal layer 22 is exposed and which is electrically connected to electrical equipment outside the solid-state battery 1. For this reason, a potential in the solid-state battery 1 can be take out.

In addition, according to the embodiment, since the first stacked electrode body 30 and the second stacked electrode body 40 are connected in series in the exterior film 20 and an insulating sheet or the like is not necessary between the first stacked electrode body 30 and the second stacked electrode body 40, a decrease in space factor of the electrode of the stacked electrode body 10 in the exterior film 20 can be suppressed. Accordingly, it is possible to reduce manufacturing costs and improve an energy density of the solid-state battery 1.

In addition, according to the embodiment, since the first stacked electrode body 30 and the second stacked electrode body 40 are connected in series at inside of the exterior film 20 and a potential of the connecting center (the first internal connecting portion 210) between the first stacked electrode body 30 and the second stacked electrode body 40 is extracted, a voltage between the first stacked electrode body 30 and the second stacked electrode body 40 can be monitored.

In addition, according to the embodiment, a potential of the connecting center (the first internal connecting portion 210) between the first stacked electrode body 30 and the second stacked electrode body 40 is equal to a potential between both stacked ends of the first stacked electrode body 30 and the second stacked electrode body 40. For this reason, even when the inner resin layer 21 of the exterior film 20 is damaged and the stacked electrode body 10 and the metal layer 22 come into contact with each other, problems such as short circuit or the like can be prevented from occurring. This is because that if the potential of the connecting center between the first stacked electrode body 30 and the second stacked electrode body 40 is equal to the potential between both stacked ends of the first stacked electrode body 30 and the second stacked electrode body 40, since the potential of the outermost surface of the exterior film 20 of the second stacked electrode body 40 is equal to the potential of the exterior film 20, the short circuit does not occur.

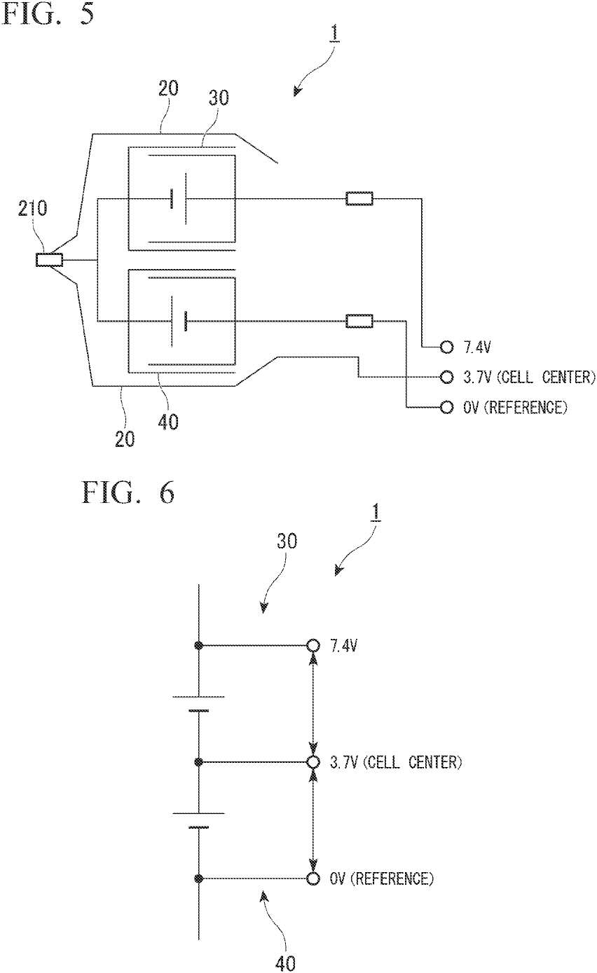

Here, description that the potential of the connecting center between the first stacked electrode body 30 and the second stacked electrode body 40 is equal to the potential between both stacked ends of the first stacked electrode body 30 and the second stacked electrode body 40 will be performed using FIG. 5 and FIG. 6.

When the entire potential of the solid-state battery 1 is 7.4 V, the potential of the connecting center between the first stacked electrode body 30 and the second stacked electrode body 40 is 3.7 V. In addition, the potential between both stacked ends of the first stacked electrode body 30 and the second stacked electrode body 40 is 3.7 V. Accordingly, the potential of the connecting center between the first stacked electrode body 30 and the second stacked electrode body 40 is equal to the potential between both stacked ends of the first stacked electrode body 30 and the second stacked electrode body 40.

In addition, when the potential of the connecting center between the first stacked electrode body 30 and the second stacked electrode body 40 is equal to the potential between both stacked ends of the first stacked electrode body 30 and the second stacked electrode body 40, for example, the entire potential of the solid-state battery 1 can be monitored by monitoring the voltage from a reference (0 V) to a connecting center (3.7 V) and a voltage from the connecting center (3.7 V) to a highest point (7.4 V).

In addition, according to the embodiment, since the metal layer 22 of the exterior film 20 is used as a part of the wiring, the wiring crossing through the solid-state battery 1 is no longer required.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A solid-state battery comprising: a stacked electrode body, and an exterior film configured to accommodate the stacked electrode body,
wherein the stacked electrode body at least has a first stacked electrode body stacked such that both stacked end outermost surfaces become a negative electrode current collector layer, and a second stacked electrode body stacked such that both stacked end outermost surfaces become a positive electrode current collector layer,
a negative electrode bundled body of a negative electrode current collector layer of the first stacked electrode body and a positive electrode bundled body of a positive electrode current collector layer of the second stacked electrode body are connected in series,
the exterior film has an inner resin layer, a metal layer, and an outer resin layer, and
an internal connecting portion configured to electrically connect the negative electrode bundled body and the positive electrode bundled body to the metal layer is provided at one end portion of the stacked electrode body in the width direction to which the negative electrode bundled body and the positive electrode bundled body are connected in series.

2. The solid-state battery according to claim 1, wherein the positive electrode bundled body of the positive electrode current collector layer of the first stacked electrode body and the negative electrode bundled body of the negative electrode current collector layer of the second stacked electrode body are each bonded to tab leads at other end portion of the stacked electrode body in the width direction,
the exterior film has an exposed portion from which the metal layer is exposed and which is electrically connected to electrical equipment outside the solid-state battery at the other end portion of the stacked electrode body in the width direction.
